(19) United States
(12) Patent Application Publication
(10) Pub. No.: US 2019/0311313 A1
(43) Pub. Date: Oct. 10, 2019

(54) METHOD FOR USE WITH A JOB, SYSTEM FOR CARRYING OUT THE METHOD AND USES

(71) Applicant: MyAbilities Technologies Inc., Burlington (CA)

(72) Inventors: Reed Hanoun, Burlington (CA); Mike Sonne, Burlington (CA); David Lithwick, Burlington (CA)

(73) Assignee: MyAbilities Technologies Inc., Burlington (CA)

(21) Appl. No.: 16/379,662

(22) Filed: Apr. 9, 2019

Related U.S. Application Data
(60) Provisional application No. 62/654,910, filed on Apr. 9, 2018.

(51) Int. Cl. G06Q 10/06; G06K 9/00

(52) U.S. Cl. CPC G06Q 10/063114; G06K 9/00771; G06Q 10/06398

(57) ABSTRACT

In the method, a predetermined group of demands, including demands that have associated parameters, are used, in respect of a shift of a job, in a process wherein, in respect of demands (i) that lack associated parameters, the amount of time that a worker, in the course of the shift, performs each demand, is derived; and (ii) that have associated parameters, each time such a demand is performed in the course of the shift, the duration, and associated parameters, is derived. The loads placed upon the muscles of the worker in the shift are calculated using, for each demand performed that is of the type that: (i) lacks associated parameters, the determined demand time and a predetermined group of load factors associated with said demand; and (ii) has associated parameters, the determined demand time, a predetermined group of load factors associated with said demand and said parameters.

### CROSS REFERENCE TO RELATED APPLICATIONS

The application claims the benefit of and priority to U.S. Provisional Patent Application No. 62/654,910 filed Apr. 9, 2018, and incorporates by reference said provisional application in its entirety.

### BACKGROUND OF THE INVENTION

### 1. Field of the Invention

The invention relates to the field of workplace injury management.

### 2. Description of the Related Art

Workplace injury places enormous costs on the economy.

It is therefore desirable to provide a method for use with a job and a system for carrying out the method and use.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### BRIEF SUMMARY OF THE INVENTION

Forming one aspect of the invention is a method for use with a job, the method comprising:
a derivation step, wherein a predetermined group of demands, said predetermined group of demands including demands that have associated parameters, are used in a process wherein, in respect of a shift of a job:
   in respect of demands in the predetermined group that lack associated parameters, the amount of time that a worker, in the course of the shift, performs each demand, is derived; and
   in respect of demands in the predetermined group that have associated parameters, each time such a demand is performed in the course of the shift, the duration and associated parameters is derived; and
a calculation step, wherein the loads placed upon the muscles of the worker in the course of the shift are calculated using,
   for each demand performed that is of the type that lacks associated parameters, the determined demand time and a predetermined group of load factors associated with said demand; and
   for each demand performed that is of the type that has associated parameters, the determined demand time, a predetermined group of load factors associated with said demand and said parameters.

According to another aspect of the invention, the derivation step can be carried out through the use of a video recording of the worker carrying out the shift.

Forming another aspect of the invention is a system for carrying out the method, this system comprising a computing facility having a video playback subfacility through which the recording can be viewed is used in the derivation step.

According to another aspect of the invention, the computing facility can be adapted to permit visual indicia to be embedded in the recording during instances when a demand is visible, the indicia identifying the demand so visible.

According to another aspect of the invention, the computing facility can be adapted to permit the parameters associated with visible demands to be entered.

Forming yet another aspect of the invention is a use of the method, wherein the ability of a candidate to perform the job is determined by an analysis of the physiological responses of the candidate to a physical test carried out over a period of time wherein the muscles of the candidate are loaded in manner such that the loads borne by the muscles over the period of time are proportional to the loads calculated to be borne by the worker over the course of the shift.

Forming yet another aspect of the invention is a use of the method, wherein the ability of the worker to continue the job is determined by an analysis of the physiological responses of the worker to a physical test carried out over a period of time wherein the muscles of the worker are loaded in manner such that the loads borne by the muscles over the period of time are proportional to the loads calculated to be borne by the worker over the course of the shift.

The foregoing has outlined in broad terms some of the more important features of the invention disclosed herein so that the detailed description that follows may be more clearly understood, and so that the contribution of the named inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

FIG. 1 is a screen shot of an exemplary system in use.

### DETAILED DESCRIPTION OF THE INVENTION

While this invention is susceptible of embodiment in many different forms, there is shown in the drawings, and will herein be described hereinafter in detail, some specific embodiments of the invention. It should be understood, however, that the disclosure is to be considered an exemplification of the principles of the invention and is not intended to limit the invention to the specific embodiments or algorithms so described.

Method Overview

As an initial matter, the method will be understood to:
be used with a predetermined group of demands, said predetermined group of demands including demands that have associated parameters;
be for use with a job; and
comprise a derivation step and a calculation step.

In the derivation step, the predetermined group of demands is used, in respect of a shift of the job, in a process wherein:
in respect of demands in the predetermined group that lack associated parameters, the amount of time that a worker, in the course of the shift, performs each demand, is derived; and
in respect of demands in the predetermined group that have associated parameters, each time such a demand is performed in the course of the shift, the duration and associated parameters is derived.

In the calculation step, the loads placed upon the muscles of the worker in the course of the shift are calculated using:
for each demand performed that is of the type that lacks associated parameters, the determined demand time and a predetermined group of load factors associated with said demand; and
for each demand performed that is of the type that has associated parameters, the determined demand time, a predetermined group of load factors associated with said demand and said parameters.

Method Detail

The basic calculation for the demand score is as follows

Job Demand Score(pre)=(PDf*BODYᵣ*F_{wt}) (Equation 1)

Where PDf is the frequency of the physical demand, BODYr is the weighted risk for each physical demand, for each body part (hands/wrists, arms, shoulders, head/neck, back, legs, knees, and feet), and Fwt is the force weighting for specific physical demands. The weightings for each physical demand by body part can be found in Table 1 below.

TABLE 1

| | Climbing | Balancing | Stooping | Kneeing | Crouching | Crawling | Reaching | Handling | Fingering | Extreme Cold |
|---|---|---|---|---|---|---|---|---|---|---|
| hands/wrists | 2 | 1 | 1 | 1 | 1 | 2 | 2 | 3 | 3 | 2 |
| arms | 2 | 1 | 1 | 1 | 1 | 1 | 3 | 3 | 1 | 2 |
| shoulders | 2 | 1 | 1 | 1 | 1 | 2 | 3 | 2 | 1 | 2 |
| head/neck | 1 | 1 | 2 | 1 | 1 | 1 | 1 | 1 | 1 | 2 |
| back | 2 | 2 | 3 | 2 | 2 | 2 | 2 | 3 | 1 | 2 |
| legs | 2 | 2 | 1 | 3 | 3 | 3 | 1 | 1 | 1 | 2 |
| knees | 2 | 2 | 1 | 3 | 3 | 3 | 1 | 1 | 1 | 2 |
| foot | 2 | 1 | 1 | 1 | 1 | 2 | 1 | 1 | 1 | 2 |

| | Vibration | Lift/Lower | Carry | Push | Pull | Grip | Pinch | Sit | Stand | Walk | Data Entry | Handling |
|---|---|---|---|---|---|---|---|---|---|---|---|---|
| hands/wrists | 2 | 2 | 2 | 2 | 2 | 3 | 3 | 1 | 1 | 1 | 2 | 2 |
| arms | 2 | 2 | 2 | 2 | 2 | 3 | 2 | 1 | 1 | 1 | 1 | 2 |
| shoulders | 2 | 3 | 3 | 3 | 3 | 2 | 1 | 1 | 1 | 1 | 1 | 2 |
| head/neck | 2 | 1 | 1 | 2 | 2 | 1 | 1 | 1 | 1 | 1 | 2 | 1 |
| back | 2 | 3 | 3 | 2 | 2 | 1 | 1 | 2 | 2 | 1 | 2 | 3 |
| legs | 2 | 1 | 2 | 1 | 1 | 1 | 1 | 1 | 1 | 1 | 1 | 1 |
| knees | 2 | 1 | 2 | 1 | 1 | 1 | 1 | 1 | 1 | 2 | 1 | 1 |
| foot | 2 | 1 | 1 | 1 | 1 | 1 | 1 | 1 | 1 | 2 | 1 | 1 |

The Frequencies are based on the Dictionary of Occupational Titles job frequencies, where:

Never=0%

Rare=1%

Infrequent=2-5%

Occasional=6-33%

Frequent=34-66%

Constant=67%>

Without entering exact frequencies, the maximum value from each frequency range will serve as the frequency used to calculate the demand score. Therefore:

Rare=0.01

Infrequent=0.05

Occasional=0.33

Frequent=0.66

Constant=1

For the force weightings, a scaled value, ranging from 0.8 to 2.0 will be used, based on comparisons to ergonomics standards. For the current physical demands in the system, there are scaling factors for lifting, pushing, pulling, and carrying, all based on the Liberty Mutual tables for manual material handling. For gripping, normative population grib values are scaled based on the Potvin MAE equation—with higher frequencies lowering the acceptable force value and increasing the force weighting. For reaching, the DINED database was used to scale population reaching norms, and building a scaling factor for horizontal reach distance. Force values that fall into column 1 are given a value of 0.8, 1, 1.4 and 2.0 for the subsequent columns.

Weighting Calculation

TABLE 2

| Lifting (kg) | | | | | | Pushing (kg) | | | | | Pulling (kg) | | | | |
|---|---|---|---|---|---|---|---|---|---|---|---|---|---|---|---|
| | Light | Medium | Medium | Heavy | | | low | med | med | high | | low | med | med | high |
| Rare | 0-10 | 10-15 | 15-21 | 21 | 1 | Rare | 0-13 | 15-19 | 19-27 | 27 | Rare | 0-14 | 19 | 19-26 | 26 |
| Infrequent | 0-9 | 9-18 | 15-18 | 18 | 2 | Infrequent | 0-12 | 12-18 | 18-23 | 23 | Infrequent | 0-12 | 18 | 18-22 | 22 |
| Occassional | 0-8 | 8-12 | 12-17 | 17 | 3 | Occassional | 0-12 | 12-16 | 16-22 | 22 | Occassional | 0-13 | 16 | 16-21 | 21 |
| Frequent | 0-7 | 7-10 | 10-15 | 15 | 4 | Frequent | 0-15 | 15-16 | 16-19 | 19 | Frequent | 0-18 | 16 | 16-19 | 19 |
| Constant | 0-5 | 6-8 | 8-12 | 12 | 5 | Constant | 13 | 15 | 15-16 | 16 | Constant | 0-14 | 14 | 14-15 | 15 |

| | | | | | Reaching | | | | | | Grip (kg) | | | | |
|---|---|---|---|---|---|---|---|---|---|---|---|---|---|---|---|
| Carrying (kg) | | | | | | 0.8 | 1.4 | 2 | | | | 0.8 | 1 | 1.4 | 2 |
| | low | med | med | high | | Very low | low | med | high | | | Light | Medium | Medium | Heavy |
| Rare | 0-16 | 16-19 | 19-22 | 22 | | | | | | 0.8 | Rare | 0-10 | 10-15 | 15-21 | 21 |
| Infrequent | 0-16 | 16-18.9 | 18.5-21 | 21 | | | | | | 0.8 | Infrequent | 0-9 | 9-18 | 15-18 | 18 |
| Occassional | 0-16 | 16-18.5 | 18.5-21 | 21 | Occassional | 0-44 | 44-98 | 68-94 | 94 | | Occassional | 0-8 | 8-12 | 12-17 | 17 |
| Frequent | 0-12 | 12-12.5 | 12.5-18 | 18 | Frequent | 0-41 | 41-61 | 61-89 | 89 | | Frequent | 0-7 | 7-10 | 10-15 | 15 |
| Constant | 15 | 16 | 16-17 | 17 | Constant | 0-36 | 56-54 | 54-83 | 83 | | Constant | 0-5 | 6-8 | 8-12 | 12 |

The Job Demand Score is equal to the sum of all body part physical demand, frequency, and force interactions.

### Example

A job is selected that has frequent lifting.

Demand Score=sum of all body part*physical demand*frequency*force weightings (Equation 2)

Force weightings are assumed to be all equal to 1 from the DOT since strength was broken down into multiple physical demands to compensate for this weighting.

For this job, there is a demand weighting of 3 for the back, a frequency of 0.66, and a force weighting of 1.0 (as there are no specific forces added automatically from the JOB^{X} database).

Back Demand Score=3*0.66*1.0=1.98. (Equation 3)

Multiple Physical Demands

The Demand Score is calculated by looking at one representative physical demand in each job. For example, if a job entails 4 separate lifts, a weighted average by duration/frequency will be calculated to provide one representative “Lift” physical demand for the entire job. If there are no tasks and there are three lifts—Occasional, Occasional, and Infrequent. The shift length is 8 hours. Shift length×frequency=hours per lift

Occasional=8 hrs*0.33=2.64 hours

Occasional=8 hrs*0.33=2.64 hours

Infrequent=8 hrs*0.05=0.4 hours

Total Lift=5 hours, 41 minutes. This represents lifting occurring for 71% of the day, or in the “constant” bin. For the purpose of the calculation for this physical demand, for the back, would be:

Demand Score(Back)=Frequency(0.71)*Body Weighing(3)*Force Weighting(1)=2.1 (Equation 4)

When there are multiple of the same physical demands that have different force weightings the individual force weighting for the lift will be calculated by weighting the percentage of total lifting time by the force multiplier for each lift. For this example, lifting is occurring for 71% of the day. The first lift is occurring for 46% of the total lifting time, the same with the second lift. The final lift (infrequent) is occurring for 7% of the total lift time. The force multipliers are calculated as a ratio with respect to known ergonomics limits. There are values of 0.8, 1, 1.4, and 2.0. If in this example, lift was has a value of 1, lift 2 has a value of 2 and lift three has a value of 1.4, their weighted contributions will be 0.46, 0.93, and 0.10, respectively. These will be summed together, producing a weighted force weighting for all lifts of 1.49. For this example, the lifting frequency will be 0.71, the force weighting will be 1.49, and the body part weighting for the back during lifting will be 3, producing a demand score of 3.18.

Multiple Tasks

Tasks durations will be used to weight the physical demands. Each individual task will have calculations performed as above—if there are multiple physical demands of the same kind, weightings will be performed as indicated above. Once each task has a representative individual physical demand (i.e. 1 lift), the duration of each task will then weight that value for the rest of the job. For example, there are three separate lifts in three different tasks, occurring for 1 hour, 2 hours, and 3 hours, respectively. Those lifts occur at frequencies of occasional, frequent, and infrequent. They have force weightings of 1.4, 0.8, and 1.0, respectively.

Effective hours=sum of all(durations*frequencies) (Equation 5)

Weighted force value=sum of all(Force multiplier*(task length/sum of all task lengths for that demand)) (Equation 6)

Body part weighting=(effective hours/shift length)*Weighted force value*body weightings (Equation 7)

Force weighting will occur based on the task duration divided by the total task durations. For this example, there is a total task time of 6 hours. Force weightings will be 0.23, 0.27, and 0.50. This results in a weighted force value of 1.0. This will produce one representative lift, that occurs for a frequency of 22.5%, a weighted force value of 1.0, and a body part weighting for the back of 3.0.

Demand Score(Back)=0.225*3*1=0.68. (Equation 8)

Rare Physical Demand Weightings

Exact frequencies of per week and per month are included in the calculations as follows. Using a similar frequency calculation as indicated above, if a demand is selected as being performed per week, or per month, those information will be calculated as a % of the day. For example, a lift that occurs for 5 seconds, once a month (indicating an 8 hour day, and a 40 hour work week), is calculated as:

5 seconds/(60 minutes*40 hours*4 weeks)=0.052% (Equation 9)

Final Calculation

Once every physical demand and every body part is calculated, the total sum of all of these scores is the overall demand score for the job.

System

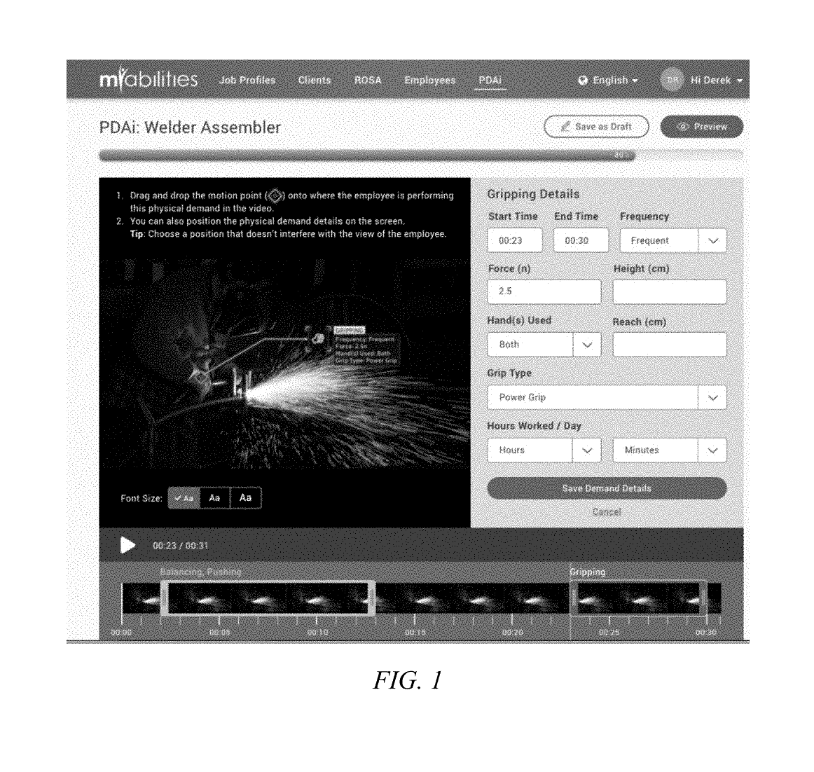

The exemplary system for carrying out the method uses the video recording and comprises a computing facility. The computing facility has a video playback subfacility through which the recording can be viewed and is adapted to permit visual indicia to be embedded in the recording during instances when a demand is visible, the indicia identifying the demand so visible, and further adapted to permit the parameters associated with visible demands to be entered. A screen shot evidencing the foregoing is reproduced as FIG. 1.

Use

The method can advantageously be used to determine the ability of a person to perform the job. To do so, the person undertakes a physical test over a period of time wherein the muscles of the person are loaded in a manner such that the loads born by the muscles over the period of time are proportional to the loads calculated to be borne by the worker over the course of the shift and the physiological responses of the person are tested for compliance with a predetermined failure protocol. If the person fails to complete the test but has physiological responses that are indicative of success, the person is deemed to be attempting to foil the test. If the person completes the test and has physiological responses that are indicative of failure, the person is deemed unable to perform the job.

It will be evident that this methodology can significant advantage in determining the ability of a job candidate to perform a job, in determining the ability of an injured worker to return to the job and in determining the desirability of remedial steps, to ensure that a worker is not injured on the job.

Variants

Whereas specific embodiments of the method, system and use are described, variations are possible.

For example, only, whereas in the described embodiment, a human viewer of the recording is used to tag demands and specify parameters, it will be readily understood that, over time, machine learning techniques will enable much of this to be at least partially automated.

Further, whereas specific reference to a shift is mentioned, it will be appreciated that this is not limiting and any time period, or group of time periods, can be used, provided that the period or periods are representative of the average demands placed upon the worker over time.

Additionally, whereas the specific parameter “force weightings” is mentioned, it will be appreciated that any number of parameters reflective of the demand placed upon the worker can be used.

Moreover, although the in exemplary embodiment, the derivation step is carried out through the use of a video recording of a worker, the derivation could, of course, be carried out, for example, through pen-and-paper visual observations.

As used herein, the term “computer” may refer, but is not limited to a laptop or desktop computer, or a mobile device, such as a desktop, laptop, tablet, cellular phone, smart phone, personal media user (e.g., iPod), wearable computer, implantable computer, or the like. Such computing devices may operate using one or more operating systems, including, but not limited to, Windows, MacOS, Linux, Unix, iOS, Android, Chrome OS, Windows Mobile, Windows CE, Windows Phone OS, Blackberry OS, and the like.

As used herein, the term “mobile device” may refer, but is not limited to any computer, as defined herein, that is not fixed in one location. Examples of mobile devices include smart phones, personal media users, portable digital assistants, tablet computers, wearable computers, implanted computers, and laptop computers.

The system and process described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The systems and/or processes described herein, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as .NET and C++, a lightweight data-interchange programming language such as JavaScript Object Notation (JSON) data-interchange format over HTTP POST request/response, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each process described above and combinations thereof may be embodied in computer executable code that, when executing on one or more computing devices, performs the steps thereof. In another aspect, the processes may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the process to be operated in a particular orientation.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Processes of the instant disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method for use with a job, the method comprising:
a derivation step, wherein a predetermined group of demands, said predetermined group of demands including demands that have associated parameters, are used, in respect of a shift of a job, in a process wherein:
in respect of demands in the predetermined group that lack associated parameters, the amount of time that a worker, in the course of the shift, performs each demand, is derived; and
in respect of demands in the predetermined group that have associated parameters, each time such a demand is performed in the course of the shift, the duration, and associated parameters, is derived; and
a calculation step, wherein the loads placed upon the muscles of the worker in the course of the shift are calculated using,
for each demand performed that is of the type that lacks associated parameters, the determined demand time and a predetermined group of load factors associated with said demand; and
for each demand performed that is of the type that has associated parameters, the determined demand time, a predetermined group of load factors associated with said demand and said parameters.

2. A method according to claim 1, wherein the derivation step is carried out through the use of a video recording of the worker carrying out the shift.

3. A system for carrying out the method of claim 2, comprising:
a computing facility having a video playback subfacility through which the recording can be viewed is used in the derivation step.

4. A system according to claim 3, wherein the computing facility is adapted to permit visual indicia to be embedded in the recording during instances when a demand is visible, the indicia identifying the demand so visible.

5. A system according to claim 4, wherein the computing facility is adapted to permit the parameters associated with visible demands to be entered.

6. Use of the method according to claim 1, wherein the ability of a candidate to perform the job is determined by an analysis of the physiological responses of the candidate to a physical test carried out over a period of time wherein the muscles of the candidate are loaded in manner such that the loads born by the muscles over the period of time are proportional to the loads calculated to be born by the worker over the course of the shift.

7. Use of the method according to claim 1, wherein the ability of the worker to continue the job is determined by an analysis of the physiological responses of the worker to a physical test carried out over a period of time wherein the muscles of the worker are loaded in manner such that the loads born by the muscles over the period of time are proportional to the loads calculated to be borne by the worker over the course of the shift.
